(19) United States
(12) Patent Application Publication
(10) Pub. No.: US 2026/0120165 A1
(43) Pub. Date: Apr. 30, 2026

(54) RECOMMENDATION DATA FOR FULFILLING AN ORDER

(71) Applicant: Walmart Apollo, LLC, Bentonville, AR (US)

(72) Inventors: Richa Sharma, Madhya Pradesh (IN); Manish Kumar Singh, Bangalore (IN); Raghavendra Giri Venkata Rentala, Andhra Pradesh (IN); Fubao Wu, Easton, PA (US); Abhinav Rai, Lucknow (IN); Ishu Garg, Bangalore (IN); Somayajula Venkata Srinivasa Rao, Jersey City, NJ (US); Ajinkya Ajay More, Santa Clara, CA (US); Salim Akhter Chowdhury, Livingston, NJ (US); Andrew B. Louderback, Cave Springs, AR (US); Andrew Walter Dean Goad, Centerton, AR (US); Zhiyang Chen, Bentonville, AR (US); Zhengyu Hu, Dallas, TX (US); Yuanzhi Gao, Milpitas, CA (US); Praniti Sinha, Brooklyn, NY (US); Douglas Blake Hobbs, Centerton, AR (US); Jagbir Singh, San Jose, CA (US); Shanil Sharma, Sunnyvale, CA (US); Arshiya Hayatkhan Pathan, Milpitas, CA (US); Sagar Gupta, Bengaluru (IN)

(21) Appl. No.: 18/929,828

(22) Filed: Oct. 29, 2024

(51) Int. Cl. G06Q 30/0601; G06Q 10/0836; G06Q 10/087

(52) U.S. Cl. CPC G06Q 30/0631; G06Q 10/0836; G06Q 10/087

(57) ABSTRACT

Examples relate to item pick-ability scores, that is whether an item is available to be picked from the node. An example may involve receiving a recommendation request regarding an order for at least one item; determining, based on the recommendation request, feature data and at least one node in a retail fulfillment network of a retailer; computing, for each item in the order and each node of the at least one node, a pick-ability score using at least one machine learning model based on the feature data, wherein the pick-ability score indicates a probability that the item is available to be picked from the node in a future time period for fulfilling the order; generating, based on the pick-ability score, recommendation data for fulfilling the order; and transmitting the recommendation data to a computing device.

### TECHNICAL FIELD

This disclosure relates to systems and methods for improving order fill rates based on accurate item pick-ability predictions.

### BACKGROUND

A retailer can fulfill orders from customers based on a retail fulfillment network formed by various nodes, e.g. stores, warehouses, fulfillment centers, etc. Inventory management and assortment planning are fundamental design decisions for a retailer, to determine what and how to place an inventory of items across different nodes in the retail fulfillment network. One key metric related to inventory management for a retailer is fill rate, which indicates a percentage of customer orders that the retailer can ship from available stock without any lost sales, backorders or out of stock according to the scheduling of the orders.

To improve fill rate, some retailers computed an available to sell (ATS) quantity merely based on inventory to determine and signal how much inventory quantities are actually available for selling an item. Such inventory and availability signals can be wrong and lead to dropping an order out of store or fulfillment center, due to operations and supply chain constraints, e.g. operation and human error, platform issues, delayed updates, unexpected demand, supply chain disruptions. This would result in a nil-pick, and decrease the fill rate for the retailers.

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for improving order fill rates and optimizing inventory management and assortment planning, in accordance with some embodiments of the present teaching;

FIG. 2 is a block diagram of a pick-ability prediction computing device, in accordance with some embodiments of the present teaching;

FIG. 3 is a block diagram illustrating various portions of a system for improving order fill rates and optimizing inventory management and assortment planning, in accordance with some embodiments of the present teaching;

FIG. 4 illustrates an example process for predicting item pick-ability scores, in accordance with some embodiments of the present teaching;

FIG. 5 illustrates an example process of running a machine learning model for item pick-ability prediction, in accordance with some embodiments of the present teaching;

FIG. 6 illustrates an example process for training a machine learning model for item pick-ability prediction, in accordance with some embodiments of the present teaching;

FIG. 7 illustrates an example process for applying a machine learning model for item pick-ability prediction, in accordance with some embodiments of the present teaching;

FIG. 8 shows a flowchart illustrating an example method for improving order fill rates and optimizing inventory management and assortment planning, in accordance with some embodiments of the present teaching.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

To improve order fill rates and optimize inventory management and assortment planning, it is critical for a retailer to accurately predict the likelihood for an item to be picked (i.e. item pick-ability) at a store or fulfillment center at a future time. One objective of various embodiments in the present teaching is to provide a system for improving order fill rates and optimizing inventory management and assortment planning based on an accurate item pick-ability prediction.

In many situations, a retailer's online availability may not match its store availability, and a pick-ability of an item may change from store to store and from time to time. In some embodiments, the system utilizes various tools and techniques to build a pick-ability model for providing an accurate item pick-ability signal. For example, given an item and a store (or an item-store pair), the pick-ability model can be used to provide a pick-ability score indicating a probability or confidence that the item will be available to be picked from the store at a future time for an order fulfillment. Such pick-ability scores can be used to determine what is the best store to source an order to ensure that the store will successfully “pick” the item, and determine what items at a given store are likely to be “picked” and “nil-picked” (i.e. where the item cannot be found and picked).

In some embodiments, the item pick-ability signal can be used to determine or select nodes (e.g. stores, warehouses, fulfillment centers, etc.) in a retail fulfillment network to source and promise an unscheduled order, where an order is shipped to the customer without scheduling a pick-up time by the customer. In some embodiments, the item pick-ability signal can be used to determine corresponding items that are at risk of going out-of-stock and need a substitution preference from the customer for a scheduled order, where an order is scheduled to be picked up by the customer, and/or recommend candidate items as substitutes for the corresponding items.

In some embodiments, the pick-ability model is created based on one or more machine learning models, which can process large and diverse data sets. In some examples, the pick-ability model comprises a daily machine learning model and an hourly machine learning model that are stacked together. The output of the daily machine learning model is used as an input to the hourly machine learning model.

The disclosed system can address challenges in machine learning and engineering aspects. For machine learning, various features are engineered to handle complexities like sparsity and noise. The pick-ability prediction problem can be treated as a classification problem, where a class imbalance approach is used to handle nil-picks. In some embodiments, department agnostic models are stacked to enhance performance. In some embodiments, the machine learning model is trained daily and is resistant to data shifts.

In some embodiments, for engineering, a functional programming approach is used for robust and scalable software. A cloud storage may be used for efficient data upserts and deletes. The Lambda architecture can be employed for efficient integration of historical and hourly data. Unique cluster indexing and data retention policies can be used for query speed and cost optimization. Partitioning and Z-ordering may be applied to optimize data access. The computed pick-ability scores can be stored in a cloud storage bucket to avoid storage costs for big queries.

In some embodiments, the system provides a solution and model that uses historic data and real time data to determine the predicted pre-substitution fill rate for an item-store pair. In some examples, the item pick-ability computed by the system using a machine learning model may be a score between 0 and 100, which represents a confidence that a given item will be successful “picked” at a given store. Using this score, companies will be able to improve their fill rates and customer net promoter score (NPS) by ensuring item and store availability.

In various embodiments, a system including a processor and a non-transitory memory storing instructions is disclosed. The instructions, when executed, cause the processor to: receive a recommendation request regarding an order for at least one item; determine, based on the recommendation request, feature data and at least one node in a retail fulfillment network of a retailer; compute, for each item in the order and each node of the at least one node, a pick-ability score using at least one machine learning model based on the feature data, wherein the pick-ability score indicates a probability that the item is available to be picked from the node in a future time period for fulfilling the order; generate, based on the pick-ability score, recommendation data for fulfilling the order; and transmit the recommendation data to a computing device.

In various embodiments, a computer-implemented method is disclosed. The computer-implemented method includes: receiving a recommendation request regarding an order for at least one item; determining, based on the recommendation request, feature data and at least one node in a retail fulfillment network of a retailer; computing, for each item in the order and each node of the at least one node, a pick-ability score using at least one machine learning model based on the feature data, wherein the pick-ability score indicates a probability that the item is available to be picked from the node in a future time period for fulfilling the order; generating, based on the pick-ability score, recommendation data for fulfilling the order; and transmitting the recommendation data to a computing device.

In various embodiments, a non-transitory computer readable medium having instructions stored thereon is disclosed. The instructions, when executed by at least one processor, cause at least one device to perform operations including: receiving a recommendation request regarding an order for at least one item; determining, based on the recommendation request, feature data and at least one node in a retail fulfillment network of a retailer; computing, for each item in the order and each node of the at least one node, a pick-ability score using at least one machine learning model based on the feature data, wherein the pick-ability score indicates a probability that the item is available to be picked from the node in a future time period for fulfilling the order; generating, based on the pick-ability score, recommendation data for fulfilling the order; and transmitting the recommendation data to a computing device.

Furthermore, in the following, various embodiments are described with respect to systems and methods for improving order fill rates and optimizing inventory management and assortment planning based on accurate item pick-ability predictions are disclosed. In some embodiments, a disclosed method includes: receiving, from a computing device, a recommendation request regarding an order for at least one item; determining, based on the recommendation request, feature data and at least one node in a retail fulfillment network of a retailer; computing, for each item in the order and each node of the at least one node, a pick-ability score using at least one machine learning model based on the feature data, wherein the pick-ability score indicates a probability that the item is available to be picked from the node in a future time period for fulfilling the order; generating, based on the pick-ability score, recommendation data for fulfilling the order; and transmitting the recommendation data to the computing device.

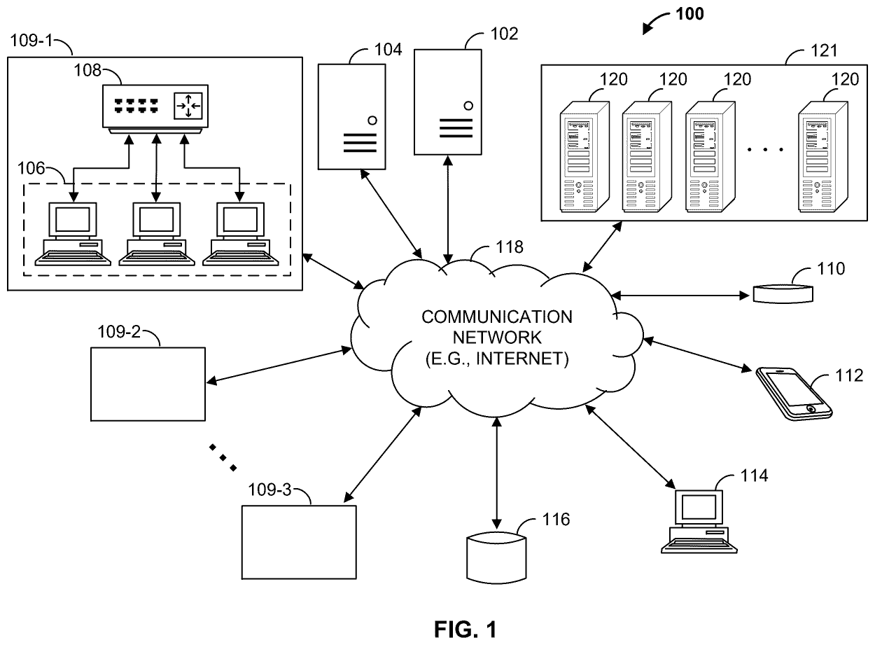

Turning to the drawings, FIG. 1 is a network environment 100 configured for improving order fill rates and optimizing inventory management and assortment planning, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a pick-ability prediction computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The pick-ability prediction computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the pick-ability prediction computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the pick-ability prediction computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the pick-ability prediction computing device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by or provided by a third party (e.g., a cloud-computing provider).

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109.

The workstation(s) 106 can communicate with the pick-ability prediction computing device 102 over the communication network 118. The workstation(s) 106 may send data to, and receive data from, the pick-ability prediction computing device 102. For example, the workstation(s) 106 may transmit data identifying transactions, inventory, supply chain data and/or waste data at the one or more fulfillment nodes 109 to the pick-ability prediction computing device 102. The workstation(s) 106 may also transmit other data related to the one or more fulfillment nodes 109 to the pick-ability prediction computing device 102.

Although FIG. 1 illustrates three user computing devices 110, 112, 114, the network environment 100 can include any number of user computing devices 110, 112, 114. Similarly, the network environment 100 can include any number of the pick-ability prediction computing devices 102, the processing devices 120, the workstations 106, the fulfillment nodes 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer's website, hosted by the server 104. The server 104 may capture user session data related to a customer's activity (e.g., interactions) on the website.

In some examples, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the pick-ability prediction computing device 102 over the communication network 118. The website may also allow the operator to add one or more of the items to an online shopping cart and allow the customer to perform a “checkout” of the shopping cart to purchase the items. In some examples, the server 104 transmits purchase data identifying items the customer has purchased from the website to the pick-ability prediction computing device 102.

In some embodiments, a customer may go to a store, e.g. the fulfillment node 109-1, for purchasing items. The customer may use some payment method, e.g. a credit card or a payment app, at the fulfillment node 109-1 to purchase one or more items. The workstation(s) 106 in the fulfillment node 109-1 may capture these activities as in-store purchase data and transmit the in-store purchase data to the pick-ability prediction computing device 102 over the communication network 118, together with other node related data.

In some examples, the pick-ability prediction computing device 102 may receive a recommendation request regarding an order for at least one item being sold by a retailer from the server 104. The recommendation request may be sent standalone or together with data associated with a retail fulfillment network (or called supply chain network or distribution network) of the retailer, to seek recommendations on how to fulfill the order from one or more nodes in the retail fulfillment network. In response, the pick-ability prediction computing device 102 generates recommendation data indicating recommendations regarding fulfilling the order from one or more nodes in the retail fulfillment network.

In some embodiments, the pick-ability prediction computing device 102 is further operable to communicate with the database 116 over the communication network 118. For example, the pick-ability prediction computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the pick-ability prediction computing device 102, in some examples, the database 116 can be a local storage device, such as a hard drive, a non-volatile memory, or a USB stick. For example, the pick-ability prediction computing device 102 may store online purchase data received from the server 104 in the database 116. The pick-ability prediction computing device 102 may receive in-store purchase data and node related data from different fulfillment nodes 109 and store them in the database 116. The pick-ability prediction computing device 102 may also receive from the server 104 user session data identifying events associated with browsing sessions and may store the user session data in the database 116. The pick-ability prediction computing device 102 may also compute recommendation data in response to a recommendation request received from the server 104 (or the fulfillment nodes 109), and may store the recommendation data in the database 116.

In some examples, the pick-ability prediction computing device 102 generates and/or updates different models (e.g., machine learning models, deep learning models, statistical models, algorithms, etc.) for improving order fill rates and optimizing inventory management and assortment planning. The pick-ability prediction computing device 102 may generate training data for the models based on data including but not limited to: historical node features, item features, inventory data, historical fill rates for orders, historical or labelled pick-ability data, historical recommendation data, and historical feedback data. The pick-ability prediction computing device 102 trains the models based on their corresponding training data, and stores the models in a database, such as in the database 116 (e.g., a cloud storage). The models, when executed by the pick-ability prediction computing device 102, allow the pick-ability prediction computing device 102 to generate recommendations for order fulfillment.

In some examples, the pick-ability prediction computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the pick-ability prediction computing device 102 may generate recommendations for order fulfillment.

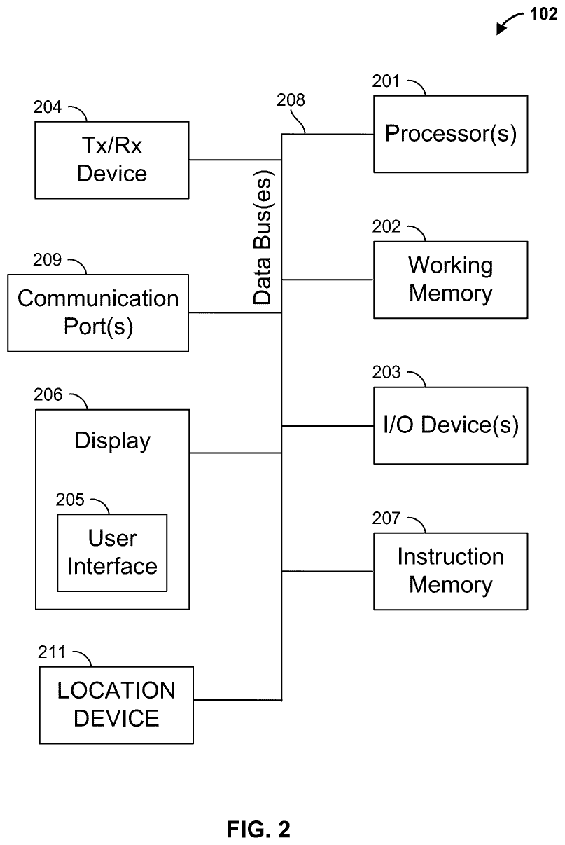

FIG. 2 illustrates a block diagram of a pick-ability prediction computing device, e.g. the pick-ability prediction computing device 102 of FIG. 1, in accordance with some embodiments of the present teaching. In some embodiments, each of the pick-ability prediction computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the pick-ability prediction computing device 102 can be combined, omitted, and/or replicated. In addition, it will be appreciated that additional elements other than those illustrated in FIG. 2 can be added to the pick-ability prediction computing device 102.

As shown in FIG. 2, the pick-ability prediction computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the pick-ability prediction computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the pick-ability prediction computing device 102 can include a single memory unit configured to operate as both instruction memory and working memory. Further, although embodiments are discussed herein including non-volatile memory, it will be appreciated that the pick-ability prediction computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the pick-ability prediction computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the pick-ability prediction computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the pick-ability prediction computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the pick-ability prediction computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the pick-ability prediction computing device 102 may determine a local geographical area (e.g., town, city, state, etc.) of its position.

In some embodiments, the pick-ability prediction computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

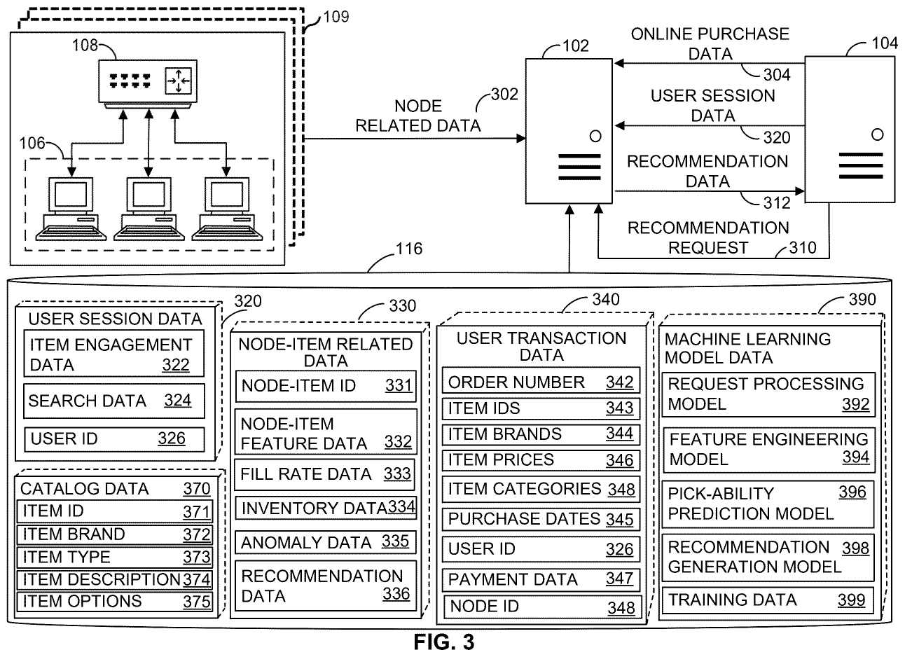

FIG. 3 is a block diagram illustrating various portions of a system for improving order fill rates and optimizing inventory management and assortment planning, e.g. the system shown in the network environment 100 of FIG. 1, in accordance with some embodiments of the present teaching. As indicated in FIG. 3, the pick-ability prediction computing device 102 may receive user session data 320 from the server 104, and store the user session data 320 in the database 116. The user session data 320 may identify, for each user (e.g., customer), data related to that user's browsing session, such as when browsing a retailer's webpage hosted by the server 104. In some embodiments, the system may not utilize all of the components and data shown in FIG. 3 for improving order fill rates and optimizing inventory management and assortment planning.

In some examples, the user session data 320 may include item engagement data 322, search data 324, and user ID 326 (e.g., a customer ID, manager ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The pick-ability prediction computing device 102 may also receive purchase data 304 from the server 104, which identifies and characterizes one or more online purchases, such as purchases made by the user and other users via a retailer's website hosted by the server 104. The pick-ability prediction computing device 102 may also receive node related data 302 from the fulfillment nodes 109, which identifies and characterizes one or more in-store purchases, product location data, inventory data, and availability data related to each of the fulfillment nodes 109. In some embodiments, the availability data may be determined based on inventory, reservation and buffer. In some embodiments, the node related data 302 may also indicate other information about the fulfillment nodes 109.

The pick-ability prediction computing device 102 may parse the node related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, or node ID 348 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some embodiments, the database 116 may further store node-item related data 330, which may identify feature data related to items and the fulfillment nodes 109. In some embodiments, the fulfillment nodes 109 are in a same retail fulfillment network of a retailer. Each of the fulfillment nodes 109 may be a store, a warehouse, a fulfillment center, or a distribution center of the retailer. The node-item related data 330 may include, for each node-item pair, one or more of: a node-item ID 331 for the node-item pair to identify the pair of node and item, node-item feature data 332 indicating node features of the node in the pair and item features related to the item in the pair, fill rate data 333 indicating a fill rate for previous orders involving the item and/or node, inventory data 334 identifying and charactering what and how many products are stocked in the node, anomaly data 335 indicating data related to detected anomalous features of the node-item pair, and recommendation data 336 indicating recommended nodes or substitute items for order fulfillment.

The database 116 may also store machine learning model data 390 identifying and characterizing one or more models and related data for improving order fill rates and optimizing inventory management and assortment planning. For example, the machine learning model data 390 may include: a request processing model 392, a feature engineering model 394, a pick-ability prediction model 396, a recommendation generation model 398 and training data 399. In various embodiments, the machine learning model data 390 includes any number of the request processing models 392, the feature engineering models 394, the pick-ability prediction models 396, and the recommendation generation models 398.

The request processing model 392 in this example can be used to collect and analyze recommendation requests from users. Each recommendation request may include information about an order for a list of items. In some examples, the recommendation request may seek recommendations about which nodes to source and promise the order. In some examples, the recommendation request may seek recommendations about which items in the order need a substitution preference and what items are good candidates for substituting these items. The request processing model 392 may be used to determine features related to the recommendation request.

The feature engineering model 394 can be used to gather and process features related to the recommendation requests, e.g. based on the features determined by the request processing model 392. In some examples, the feature engineering model 394 is used to transform different features with various data formats to a table which can be written to a query. In some examples, the feature engineering model 394 is used to construct a feature by combining all data from different jobs and tables, to generate queries. In some examples, the feature engineering model 394 is used to combine all features to create a design matrix, which can feed into the pick-ability prediction model 396 to produce pick-ability inferences.

The pick-ability prediction model 396 in this example can be used to compute pick-ability scores, e.g. based on features processed by the feature engineering models 394 using various engineering techniques. In some examples, the pick-ability prediction model 396 includes a first machine learning model and a second machine learning model. The first machine learning model is a daily model that is used daily for inference, while the second machine learning model is an hourly model that is used hourly for inference. In some embodiments, the two models are stacked together, where prediction probabilities output from the daily model are used as input features to the hourly model, making the pick-ability prediction model 396 more compact and accurate than the daily model or the hourly model alone. In some embodiments, both the daily model and the hourly model are trained daily. In some embodiments, different pick-ability prediction models 396 are used for different business units or item categories, with different sets of hyperparameters. A pick-ability score for an item is computed using a pick-ability prediction model 396 corresponding to a business unit of the item.

The recommendation generation model 398 in this example can be used to generate recommendation data for order fulfillment. In some examples, the recommendation generation model 398 is used to generate different recommendation data based on the pick-ability scores for different recommendation requests. For example, the recommendation generation model 398 may be used to rank different nodes based on their respective pick-ability scores regarding a same item, to select top one or more nodes to promise or fulfill the item delivery. For example, the recommendation generation model 398 may be used to rank different items based on their respective pick-ability scores regarding a same node, to select top one or more candidate items as substitutes for an out-of-stock item in an order to be picked up from the node. In some embodiments, the recommendation generation model 398 includes an anomaly detection model for monitoring the performance of the system, detecting any anomaly of the system, and reporting the anomaly and its corresponding insight data.

In some embodiments, one or more of the request processing models 392, the feature engineering models 394, the pick-ability prediction models 396, and the recommendation generation models 398 can be implemented as a machine learning model. The training data 399 may include data utilized for training one or more of the request processing models 392, the feature engineering models 394, the pick-ability prediction models 396, and the recommendation generation models 398. In some examples, the training data 399 may be formed based on: node features, item features, inventory data, fill rates for orders, historical or labelled pick-ability data, historical or labelled recommendation data, obtained from either real data or synthetic data.

In some examples, the pick-ability prediction computing device 102 receives a recommendation request 310, e.g., from the server 104. The recommendation request 310 may be associated with an order for at least one item and a retail fulfillment network of a retailer, e.g. the retailer associated with the pick-ability prediction computing device 102 and/or the server 104. In some examples, the recommendation request 310 is to seek recommendations for fulfilling the order. In some embodiments, the pick-ability prediction computing device 102 may determine at least one node in the retail fulfillment network and determine feature data related to the at least one item and/or the at least one node from the database 116, based on the recommendation request 310. Based on the feature data, the pick-ability prediction computing device 102 may compute, for each item in the order and each node of the at least one node, a pick-ability score using at least one machine learning model. The at least one machine learning model may include any model in the recommendation model data 390, e.g. the pick-ability prediction model 396. The pick-ability prediction computing device 102 can generate recommendation data 312 for fulfilling the order based on the pick-ability score. In response to the recommendation request 310, the pick-ability prediction computing device 102 may transmit the recommendation data 312 to the server 104.

In some embodiments, the pick-ability prediction computing device 102 may assign one or more of the above described operations to a different processing unit or virtual machine hosted by one or more processing devices 120. Further, the pick-ability prediction computing device 102 may obtain the outputs of the these assigned operations from the processing units and generate the recommendation data 312 based on the outputs.

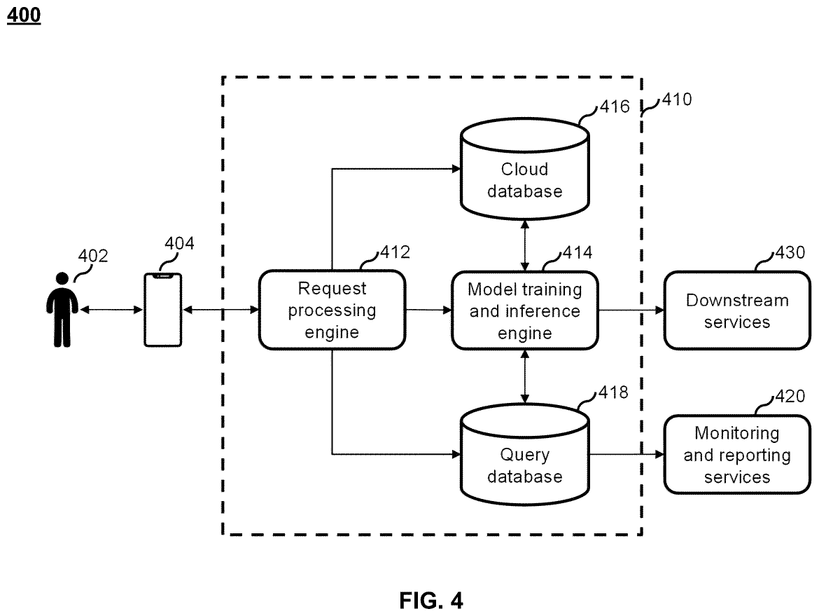

FIG. 4 illustrates an example process 400 for predicting item pick-ability scores, in accordance with some embodiments of the present teaching. In some embodiments, the process 400 can be carried out by one or more computing devices, such as the pick-ability prediction computing device 102, the server 104, and/or the cloud-based engine 121 of FIG. 1.

As shown in FIG. 4, the process 400 starts from a user 402 interacting with a user device 404, which may be one of the user computing devices 110, 112, 114. For example, the user 402 may place an order on a website or app hosted by the server 104 via the user device 404. The order can trigger a recommendation request to a system 410, which may be implemented on the pick-ability prediction computing device 102, the server 104, and/or the cloud-based engine 121 of FIG. 1.

As shown in FIG. 4, the system 410 includes a request processing engine 412, a model training and inference engine 414, a cloud database 416 and a query database 418. The request processing engine 412 in this example can receive a recommendation request regarding an order for at least one item placed by the user 402, e.g. via the user device 404 and the server 104 hosting the website or app. In some embodiments, the request processing engine 412 also determines, based on the recommendation request, feature data and at least one node in a retail fulfillment network of a retailer.

In some embodiments, each node in the retail fulfillment network comprises at least one of: a store, a warehouse, a fulfillment center, or a distribution center. In some embodiments, the feature data comprises data related to at least one of: a business unit of each item in the order; a category of each item in the order; fulfillment scheduling information of the order; customer-provided information of the order; item-related features of each item in the order; or node-related features of each node in the retail fulfillment network.

In some embodiments, the request processing engine 412 stores the feature data at the cloud database 416, which may be part of the database 116 or a standalone database. In addition, the request processing engine 412 can generate or trigger queries stored in the query database 418. For example, the recommendation request can be processed to create one or more big query jobs using functional programming constructs to handle elemental and feature data. The big query jobs are stored in the query database 418, and are pulled by the model training and inference engine 414 for generating recommendation data, which results in a robust, maintainable, and scalable system.

The model training and inference engine 414 can train at least one machine learning model, and compute, for each item in the order and each node of the at least one node, a pick-ability score using the at least one machine learning model based on the feature data. The pick-ability score indicates a probability or confidence that the item will be available to be picked from the node at a future time for fulfilling the order. The at least one machine learning model may include one or more of the models in the machine learning model data 390.

The pick-ability scores computed by the model training and inference engine 414 can be utilized by downstream services 430 to make decisions on how to improve fill rates, how to manage inventories at different nodes, how to modify or update assortment at different nodes, how to optimize supply chain scheduling and placement, etc. In some examples, monitoring and reporting services 420 are utilized to monitor results of queries and results of recommendations, which indicates performances of the machine learning model and the system 410. The monitoring and reporting services 420 can report key metrics indicating system performance and report an alert if any anomaly is detected during running of the system 410 to associates or engineers of the retailer.

In some embodiments, the model training and inference engine 414 can train the machine learning model daily and store the trained model in the cloud database 416. In some embodiments, the model training and inference engine 414 can retrieve the trained model from the cloud database 416 hourly for inference. In some embodiments, the model training and inference engine 414 can also generate, based on the pick-ability score, recommendation data for fulfilling the order, and transmit the recommendation data to the server 104.

In some embodiments, the order is associated with a scheduled time for the user 402 to pick up the at least one item at a pre-determined node. The model training and inference engine 414 can determine, in the order, a first item having a pick-ability score lower than a first threshold; and determine, for the first item, at least one substitute item each as a candidate for substituting the first item in the order. The recommendation data in this example indicates the at least one substitute item. The user 402 may select, from the at least one substitute item, an item to substitute the first item to fulfill the order at the scheduled time.

In some embodiments, after the user 402 places the order, the system 410 informs the user 402 that the first item will likely be out of stock at the scheduled time at a pre-determined pick-up node. This may be for a scheduled order, where a customer has selected whether the order is to be fulfilled by online delivery or customer pickup. The customer has specified a time slot and a store for the pickup. In some examples, the customer has the order fulfilled with a scheduled delivery, where the customer can specify a time slot for the order to be delivered to the customer in that specific time slot. In these cases, the user 402 can change the pick-up node, change the scheduled time, and/or provide preferred substitute items for the first item. In some examples, the system 410 receives, from the user 402 via the website, a first list of substitute items as preferred items for substituting the first item. The model training and inference engine 414 can compute, for each respective item of the first list of substitute items, a pick-ability score indicating a probability or confidence that the respective item is available to be picked up from the pre-determined node at the scheduled time. The model training and inference engine 414 may generate a ranked list of items by ranking the first list of substitute items based on their respective pick-ability scores; and select one or more top ranked items in the ranked list as the at least one substitute item based on a pre-determined threshold.

In some embodiments, the at least one item includes a plurality of items in the order; the at least one node includes a plurality of nodes in the retail fulfillment network; and the order is an unscheduled order to be fulfilled by shipping the plurality of items from one node of the plurality of nodes. Then for each respective item of the plurality of items in the order: the model training and inference engine 414 can generate a ranked list of nodes by ranking the plurality of nodes based on their respective pick-ability scores regarding the respective item. The model training and inference engine 414 may select one or more nodes (e.g. top 10 or top 10%) that are top ranked in the ranked list based on a pre-determined threshold; and recommend, from the selected nodes for the plurality of items in the order, a single node for fulfilling the unscheduled order. The recommendation data in this example indicates the single node for shipping the unscheduled order. The retailer will then pick items in the order from the single node (which is likely pick-able) at the future time to fill the order.

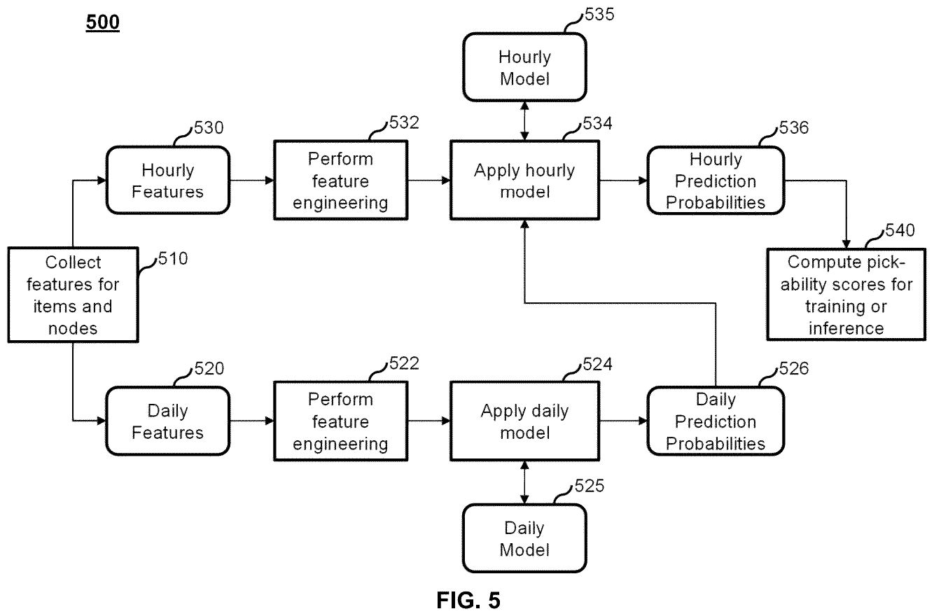

FIG. 5 illustrates an example process 500 of running a machine learning model for item pick-ability prediction, in accordance with some embodiments of the present teaching. In some embodiments, the machine learning model is one model of the machine learning model data 390 (e.g. the pick-ability prediction model 396) in FIG. 3. In some embodiments, the process 500 can be carried out by one or more computing devices, such as the pick-ability prediction computing device 102 and/or the cloud-based engine 121 of FIG. 1.

As shown in FIG. 5, the process 500 starts from operation 510, where features for items and nodes are collected. In some examples, the system collects diverse array of features in different formats from different sources. Some of the features are historical features related to item transactions and order fulfillments. Some of the features are static features related to items and nodes, e.g. item ID, node ID, node location, etc.

During a training stage, the features collected at the operation 510 can be used to generate training data to train the machine learning model. The machine learning model is trained to compute pick-ability scores each being a value for a respective node and a respective item to represent a confidence that the respective item will be picked from the respective node at a given time. After the training stage, the machine learning model can have hyperparameters determined to optimize the performance of the machine learning model, e.g. based on labels in the training data. During an inference stage, the features collected at the operation 510 can be used as input features for the machine learning model to compute pick-ability scores each being a value for a respective node and a respective item to represent a confidence that the respective item will be picked from the respective node at a given time.

The collected features include daily features 520 and hourly features 530. At operation 522, feature engineering is performed on daily features 520. In parallel at operation 532, feature engineering is performed on hourly features 530. The feature engineering performed at the operations 522, 532 are to overcome certain complexities like sparsity, bias, noise, etc. In some examples, matrix factorization is used to compute pick rate of an item-store pair to address the sparsity issue. To reduce noise around inventory data, the system can compute interactive features (with varying lookback windows) from multiple sources that are part of inventory equation like sales, receiving, etc. In some embodiments, a prediction of pick or nil-pick for an item-store pair can be treated as a classification problem. As nil-picks (where the item cannot be found and picked) typically occur at a low frequency (e.g. 10% of times), the system can apply a class imbalance approach to down-sample or under-sample majority class by choosing sampling threshold with highest F1-score (e.g. using the F1-score vs threshold plot).

In some examples, during a training stage, the training data includes feature data of samples and label data classifying the samples as positive samples that are picked and negative samples that are not picked. The feature engineering performed at the operations 522, 532 may include: removing sparsity of pick rate data (or fill rate data) in the training data by computing pick rates for node-item pairs in the training data using matrix factorization; reducing noise of inventory data in the training data by computing interactive features with varying lookback windows from multiple sources; and reducing bias of the label data in the training data by down-sampling the positive samples in the training data using a sampling threshold selected based on a highest F1 score.

In some embodiments, the sampling threshold may be one of the hyperparameters to be tuned and trained for the machine learning model. The system can try different types of thresholds and determine performance of the machine learning model based on those different thresholds. The sampling threshold may be determined to optimize the model performance.

As shown in FIG. 5, the machine learning model comprises a daily model 525 and an hourly model 535. The daily model 525 is applied at operation 524 based on the engineered daily features from the operation 522, to generate daily prediction probabilities 526. These daily prediction probabilities 526 can indicate a probability, for each item-node pair, that the item will be successfully picked from the node at a given time.

The daily prediction probabilities 526 output from the daily model 525 are used as input features to the hourly model 535, when applying the hourly model 535 at the operation 534. As such, the daily model 525 and the hourly model 535 are stacked together to form one machine learning model, to enhance the performance of the machine learning model. The stacked machine learning model is more compact and accurate than either of the daily model 525 and the hourly model 535 alone. For example, an item could be available in a store in the morning, but then became unavailable in the afternoon of the same day.

At the operation 534, the hourly model 535 is applied based on: (a) the engineered hourly features from the operation 532 and (b) the daily prediction probabilities 526 from the operation 524, to generate hourly prediction probabilities 536. In some embodiments, the daily prediction probabilities 526 and the hourly prediction probabilities 536 can indicate item pick probabilities, item nil-pick probabilities, or both.

At operation 540, the hourly prediction probabilities 536 is used to compute pick-ability score for training the machine learning model or inference using the machine learning model. In some embodiments, each hourly prediction probability (p) can be converted into a pick-ability score on a scale between 0 and 100, with a unique scoring formulation, e.g. based on output requirement of end consumers. In some examples, similar probabilities for a department (d) at a given time (t) are grouped together and mapped to a recent seven-day pick rate for items (r) in that group (R(p)), to compute the pick-ability score according to the following equation:

$$Score ( p ; d , t ) = \sum total\_picks / \sum total\_orders ∀ r ∈ R ( p ) .$$

In some embodiments, the machine learning model comprises an eXtreme Gradient Boosting (XGBoost) model created for each respective business unit of a plurality of business units of a retailer. For example, six XGBoost models can be created, each for a respective strategic business unit (SBU) of six SBU's, e.g. food, home, hardlines, electronic-toys-seasonal, consumables and apparels. Each XGBoost model is trained to generate a respective set of hyperparameters (e.g. depth of a decision tree, down-sampling fraction, down-sampling threshold, etc.) for the respective SBU. The SBU level machine learning model is at a higher hierarchy than the department level models (which would need 50+ models). Such XGBoost models are department agnostic and can offer equivalent performance at a fraction of the maintenance and resource consumption.

In some embodiments, each machine learning model (for a corresponding business unit) is trained daily using the most recent order data but is applied hourly to compute pick-ability scores, which is not only cost-effective but also proved to be resistant to data shifts.

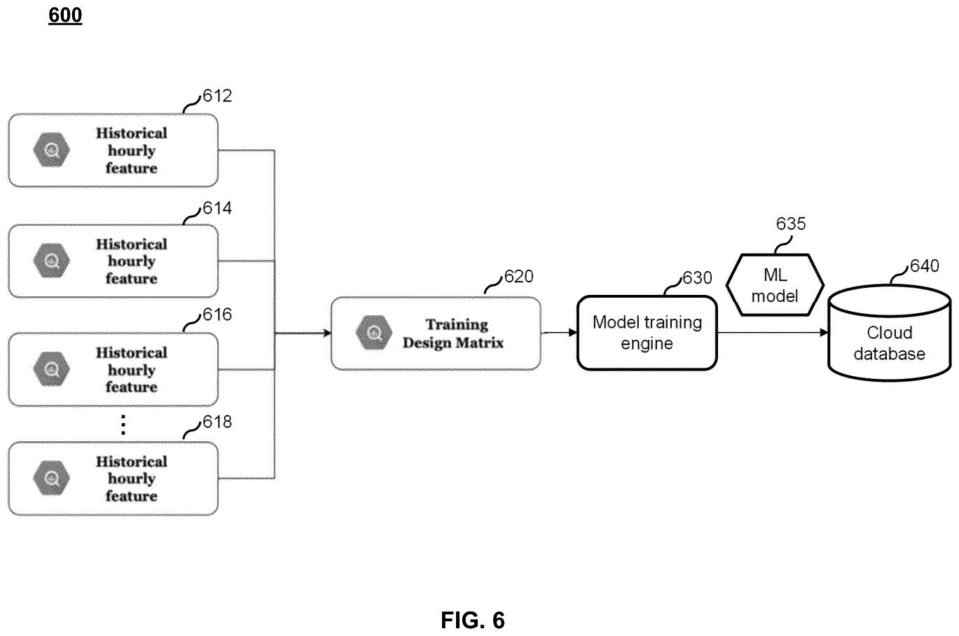

FIG. 6 illustrates an example process 600 for training a machine learning model for item pick-ability prediction, in accordance with some embodiments of the present teaching. In some embodiments, the machine learning model is one model of the machine learning model data 390 (e.g. the pick-ability prediction model 396) in FIG. 3. In some embodiments, the process 600 can be carried out by one or more computing devices, such as the pick-ability prediction computing device 102 and/or the cloud-based engine 121 of FIG. 1.

As shown in FIG. 6, the process 600 starts from collecting historical hourly features 612, 614, 616, 618, which may include features related to items, nodes, previous orders, order fill rates (a percentage of time a node was able to fulfill orders for a given item), etc. A fill rate for an item in a store can be computed based on a pick quantity of the item divided by the order quantity for the item. Since the fill rate data may be empty for most items in a store given a time period for collecting the historical data, matrix factorization may be utilized to estimate the fill rate for each item in the store to collect these historical features. These historical hourly features 612, 614, 616, 618 can be combined together to generate a training design matrix 620. Then, a model training engine 630 can train a machine learning model 635 using the training design matrix 620 as training data. In some embodiments, the machine learning model 635 is a reinforcement learning model, which tries to optimize fill rates for items, with new fill rates being fed back into the model to re-train the model.

The trained machine learning model 635 can be stored in a cloud database 640, which may be part of the database 116 or a standalone database. In some embodiments, the model training engine 630 may be at least part of the model training and inference engine 414 in FIG. 4, and the cloud database 640 may be at least part of the cloud database 416 in FIG. 4.

In some embodiments, different machine learning models 635 are trained based on historical hourly features related to different business units, respectively. The different machine learning models 635 will have different sets of hyperparameters, to be applied during an inference stage to compute pick-ability scores.

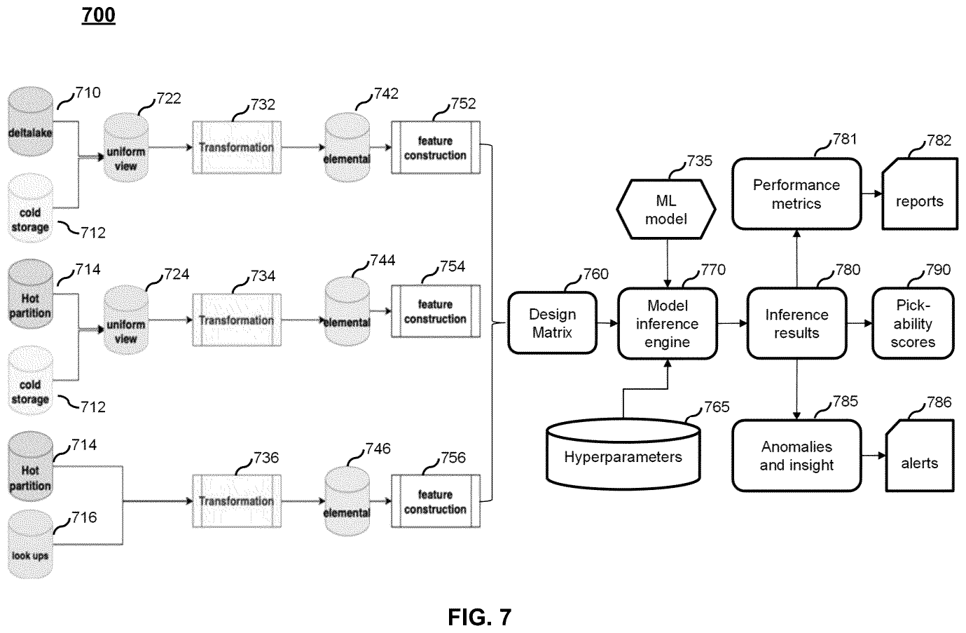

FIG. 7 illustrates an example process 700 for applying a machine learning model for item pick-ability prediction, in accordance with some embodiments of the present teaching. In some embodiments, the machine learning model is one model of the machine learning model data 390 (e.g. the pick-ability prediction model 396) in FIG. 3. In some embodiments, the process 700 can be carried out by one or more computing devices, such as the pick-ability prediction computing device 102 and/or the cloud-based engine 121 of FIG. 1.

As shown in FIG. 7, the process 700 covers from collecting data at an ingestion layer of the machine learning model, to storing and publishing of pick-ability scores to downstream services. At the ingestion layer, the system can collect data from various sources including: a data lake 710 which is a format agnostic storage for sales receiving on hand, a cold storage 712 which is a data warehouse for storing cold and static data, a hot partition 714 storing data that changes very fast and needs to be computed on the fly, a look up database 716 storing look up tables with query and underlying data already indexed therein for faster lookups.

In some embodiments, data from these sources are retrieved hourly through an hourly pipeline and are engineered to be highly available to meet hourly service-level agreements. For example, data from the data lake 710 and the cold storage 712 are combined in a uniform view 722, to go through transformation 732 to generate an elemental table 742 as a transformed data source. A feature construction 752 is then performed to write the elemental table 742 into queries, e.g. a big queries. For example, the system can pull the data from elemental jobs from the elemental table 742, and construct features to be written into big queries.

Similarly, data from the hot partition 714 and the cold storage 712 are combined in a uniform view 724, to go through transformation 734 to generate an elemental table 744 as a transformed data source. A feature construction 754 is then performed to write the elemental table 744 into big queries. In addition, data from the hot partition 714 and the look up database 716 are combined to go through transformation 736 to generate an elemental table 746 to be written into big queries by a feature construction 756.

In the example shown in FIG. 7, the transformations 732, 734, 736 are performed in parallel in three branches, while the feature constructions 752, 754, 756 are also performed in parallel in the three branches. The process 700 may be implemented through any number of branches in other examples. Then, the system can generate a design matrix 760 by combining all features of items and nodes from big queries, based on feature transformation, construction and concatenation. The design matrix 760 may be used as an input to a model inference engine 770 to perform hourly inference based on a machine learning model 735. In some embodiments, the model inference engine 770 may be at least part of the model training and inference engine 414 in FIG. 4, and the machine learning model 735 may be one of the trained machine learning models 635 in FIG. 6.

In some embodiments, for each item-node pair, the model inference engine 770 can determine, from a plurality of business units, a corresponding business unit based on the item. Then, the model inference engine 770 can determine and retrieve the machine learning model 735 (e.g. an XGBoost model) trained for the corresponding business unit, with a corresponding set of hyperparameters 765. The model inference engine 770 can input the design matrix 760 into the machine learning model 735 to generate inference results 780 based on the corresponding set of hyperparameters 765 generated for the corresponding business unit.

The inference results 780 may include pick-ability scores 790 each for a corresponding item-node pair. These pick-ability scores 790 may be used by downstream services for recommending nodes to promise orders, recommending candidate items to substitute an out-of-stock item in an order, optimizing inventory management and assortment planning to improve order fill rates and reduce nil-picks, etc. In some embodiments, the system can monitor and report performance of the machine learning model 735, e.g. via a user interface based on pre-determined performance metrics 781. For example, the system can monitor the inference results 780 based on the performance metrics 781 to generate reports 782 about the system and model performance. The system can also monitor the inference results 780 to detect anomalies of the system and/or machine learning model 735 during computing the pick-ability scores. The system can determine and generate insight data indicating causes for the anomalies, and generate alerts 786 to report the anomalies and insight 785, e.g. via the user interface.

In some embodiments, the system can re-train the machine learning model 735 based on: the anomalies and insight 785, user feedback regarding the alerts 786, and updated training data with updated pick rates. The re-trained machine learning model 735 may have a new corresponding set of hyperparameters.

In some embodiments, the implementation of big query jobs using functional programming constructs to handle elemental and feature data, which results in robust, maintainable, and scalable software. In some embodiments, the system uses data lake for efficient and faster upserts and delete functionality in the ingestion layer, ensures data consistency and integrity and is reconciled with most hourly updates for feature engineering. The system can employ Lambda architecture for efficient and fault-tolerant amalgamation of historical data with the most recent hourly updates. In some embodiments, the system uses a unique cluster index (for department, store and item levels) in the storage layer to enhance query speed and a multi-day data retention policy to minimize big query costs. In some embodiments, partitioning and Z-ordering are utilized on data in cloud storage to optimize data access by significantly decreasing the volume of data scanned by underlying query engines. In some embodiments, pick-ability scores are stored in a cloud storage bucket to avoid big query storage costs. The pick-ability scores can be retained for a long period (e.g. a year), with an external big query table linked to this bucket created for ad-hoc analytics without a need for a cluster.

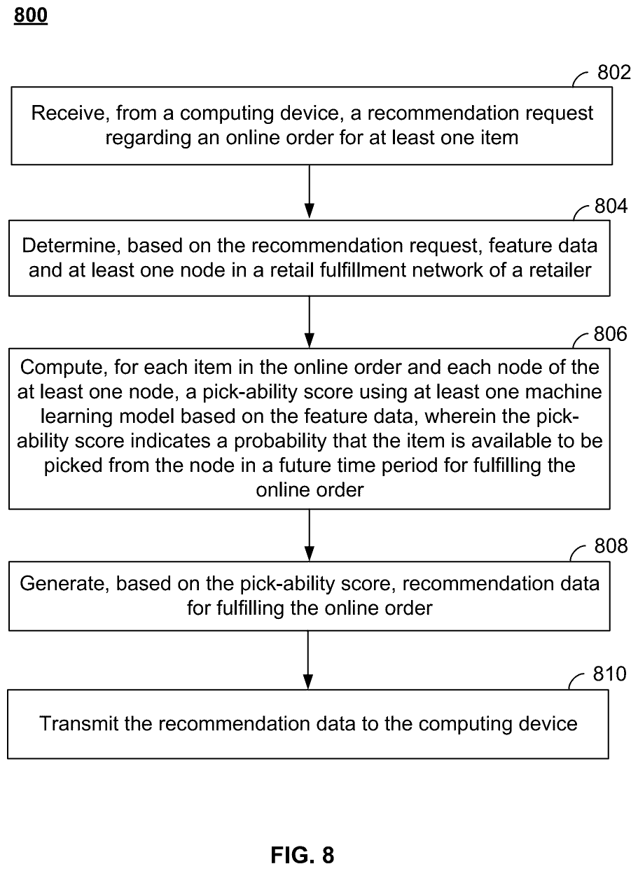

FIG. 8 shows a flowchart illustrating an example method 800 for improving order fill rates and optimizing inventory management and assortment planning, in accordance with some embodiments of the present teaching. In some embodiments, the method 800 can be carried out by one or more computing devices, such as the pick-ability prediction computing device 102 and/or the cloud-based engine 121 of FIG. 1. Beginning at operation 802, a recommendation request regarding an order for at least one item is received from a computing device. At operation 804, feature data and at least one node in a retail fulfillment network of a retailer are determined based on the recommendation request. At operation 806, for each item in the order and each node of the at least one node, a pick-ability score is computed using at least one machine learning model based on the feature data. The pick-ability score indicates a probability that the item is available to be picked from the node in a future time period for fulfilling the order. At operation 808, recommendation data for fulfilling the order is generated based on the pick-ability score. The recommendation data is transmitted at operation 810 to the at least one store.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
receive a recommendation request regarding an order for at least one item,
determine, based on the recommendation request, feature data and at least one node in a retail fulfillment network of a retailer,
compute, for each item in the order and each node of the at least one node, a pick-ability score using at least one machine learning model based on the feature data, wherein the pick-ability score indicates a probability that the item is available to be picked from the node in a future time period for fulfilling the order,
generate, based on the pick-ability score, recommendation data for fulfilling the order, and
transmit the recommendation data to a computing device.

2. The system of claim 1, wherein each node in the retail fulfillment network comprises at least one of:
a store, a warehouse, a fulfillment center, or a distribution center.

3. The system of claim 1, wherein the feature data comprises data related to at least one of:
a business unit of each item in the order;
a category of each item in the order;
fulfillment scheduling information of the order;
customer-provided information of the order;
item-related features of each item in the order; or
node-related features of each node in the retail fulfillment network.

4. The system of claim 1, wherein:
the order is associated with a scheduled time for a customer to pick up the at least one item at a pre-determined node;
the processor is configured to:
determine, in the order, a first item having a pick-ability score lower than a first threshold, and
determine, for the first item, at least one substitute item each as a candidate for substituting the first item in the order; and
the recommendation data indicates the at least one substitute item.

5. The system of claim 4, wherein the at least one substitute item is determined based on:
receiving, from the customer, a first list of substitute items as preferred items for substituting the first item;
computing, for each respective item of the first list of substitute items, a pick-ability score indicating a probability that the respective item is available to be picked up from the pre-determined node at the scheduled time;
generating a ranked list of items by ranking the first list of substitute items based on their respective pick-ability scores; and
selecting one or more top ranked items in the ranked list as the at least one substitute item based on a pre-determined threshold.

6. The system of claim 1, wherein:
the at least one item includes a plurality of items in the order;
the at least one node includes a plurality of nodes in the retail fulfillment network; and
the order is an unscheduled order to be fulfilled by shipping the plurality of items from one node of the plurality of nodes.

7. The system of claim 6, wherein the processor is configured to:
for each respective item of the plurality of items in the order:
generate a ranked list of nodes by ranking the plurality of nodes based on their respective pick-ability scores regarding the respective item, and
select one or more nodes that are top ranked in the ranked list based on a pre-determined threshold; and
recommend, from the selected nodes for the plurality of items in the order, a single node for fulfilling the unscheduled order,
wherein the recommendation data indicates the single node for shipping the unscheduled order.

8. The system of claim 1, wherein the at least one machine learning model is trained based on:
generating training data based on historical features; and
training the at least one machine learning model to compute pick-ability scores each being a value for a respective node and a respective item to represent a confidence that the respective item will be picked from the respective node at a given time.

9. The system of claim 8, wherein the training data is generated based on:
obtaining training data based on historical features, wherein the training data includes feature data of samples and label data classifying the samples as positive samples that are picked and negative samples that are not picked;
removing sparsity of pick rate data in the training data by computing pick rates for node-item pairs in the training data using matrix factorization;
reducing noise of inventory data in the training data by computing interactive features with varying lookback windows from multiple sources; and
reducing bias of the label data in the training data by down-sampling the positive samples in the training data using a sampling threshold selected based on a highest F1 score.

10. The system of claim 1, wherein:
the at least one machine learning model comprises a daily model and an hourly model that are stacked together;
prediction probabilities output from the daily model are used as input features to the hourly model; and
the at least one machine learning model is trained daily and applied hourly to compute pick-ability scores.

11. The system of claim 1, wherein:
the at least one machine learning model comprises a gradient boosting model created for each respective business unit of a plurality of business units of the retailer; and
each gradient boosting model is trained to generate a respective set of hyperparameters for the respective business unit.

12. The system of claim 11, wherein the pick-ability score is computed based on:
generating a design matrix including features of the item and the node based on feature transformation, construction and concatenation;
determining, from the plurality of business units, a corresponding business unit based on the item;
determining a corresponding gradient boosting model created for the corresponding business unit; and
inputting the design matrix into the corresponding gradient boosting model to compute the pick-ability score based on a corresponding set of hyperparameters generated for the corresponding business unit.

13. The system of claim 1, wherein the processor is configured to:
monitor and report performance of the at least one machine learning model via a user interface based on pre-determined performance metrics;
detect an anomaly of the at least one machine learning model during computing the pick-ability scores;
generate insight data indicating causes for the anomaly;
report, via the user interface, an alert including the anomaly and the insight data; and
re-train the at least one machine learning model based on: the insight data, a user feedback regarding the alert, and updated training data with updated pick rates.

14. A computer-implemented method, comprising:
receiving a recommendation request regarding an order for at least one item;
determining, based on the recommendation request, feature data and at least one node in a retail fulfillment network of a retailer;
computing, for each item in the order and each node of the at least one node, a pick-ability score using at least one machine learning model based on the feature data, wherein the pick-ability score indicates a probability that the item is available to be picked from the node in a future time period for fulfilling the order;
generating, based on the pick-ability score, recommendation data for fulfilling the order; and
transmitting the recommendation data to a computing device.

15. The computer-implemented method of claim 14, wherein:
the order is associated with a scheduled time for a customer to pick up the at least one item at a pre-determined node; and
the method further comprises:
determining, in the order, a first item having a pick-ability score lower than a first threshold,
determining, for the first item, at least one substitute item each as a candidate for substituting the first item in the order; and
the recommendation data indicates the at least one substitute item.

16. The computer-implemented method of claim 15, wherein determining the at least one substitute item comprises:
receiving, from the customer, a first list of substitute items as preferred items for substituting the first item;
computing, for each respective item of the first list of substitute items, a pick-ability score indicating a probability that the respective item is available to be picked up from the pre-determined node at the scheduled time;
generating a ranked list of items by ranking the first list of substitute items based on their respective pick-ability scores; and
selecting one or more top ranked items in the ranked list as the at least one substitute item based on a pre-determined threshold.

17. The computer-implemented method of claim 14, wherein:
the at least one item includes a plurality of items in the order;
the at least one node includes a plurality of nodes in the retail fulfillment network; and
the order is an unscheduled order to be fulfilled by shipping the plurality of items from one node of the plurality of nodes.

18. The computer-implemented method of claim 17, further comprising:
for each respective item of the plurality of items in the order:
generating a ranked list of nodes by ranking the plurality of nodes based on their respective pick-ability scores regarding the respective item, and
selecting one or more nodes that are top ranked in the ranked list based on a pre-determined threshold; and
recommending, from the selected nodes for the plurality of items in the order, a single node for fulfilling the unscheduled order,
wherein the recommendation data indicates the single node for shipping the unscheduled order.

19. The computer-implemented method of claim 14, wherein:
the at least one machine learning model comprises a daily model and an hourly model that are stacked together;
prediction probabilities output from the daily model are used as input features to the hourly model; and
the at least one machine learning model is trained daily and applied hourly to compute pick-ability scores.

20. A non-transitory computer readable medium having instructions stored thereon, wherein the instructions, when executed by at least one processor, cause at least one device to perform operations comprising:
receiving a recommendation request regarding an order for at least one item;
determining, based on the recommendation request, feature data and at least one node in a retail fulfillment network of a retailer;
computing, for each item in the order and each node of the at least one node, a pick-ability score using at least one machine learning model based on the feature data, wherein the pick-ability score indicates a probability that the item is available to be picked from the node in a future time period for fulfilling the order;
generating, based on the pick-ability score, recommendation data for fulfilling the order; and
transmitting the recommendation data to a computing device.
